(19) United States
(12) Patent Application Publication
(10) Pub. No.: US 2008/0173060 A1
(43) Pub. Date: Jul. 24, 2008

(54) METHOD AND APPARATUS FOR FORMING UNDULATING CONDUIT

(75) Inventors: Lubomyr M. Cymbalisty, Edmonton (CA); Frederick Arthur Hemphill, Victoria (CA)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Undultec, Inc., Edmonton (CA)

(21) Appl. No.: 11/956,707

(22) Filed: Dec. 14, 2007

Related U.S. Application Data
(60) Provisional application No. 60/874,848, filed on Dec. 14, 2006.

(51) Int. Cl. B01F 13/00; B21D 9/04

(52) U.S. Cl. 72/369; 138/177; 138/DIG. 11; 366/341

(57) ABSTRACT

Method and apparatus for forming conduit or pipe of various sizes into undulating, helical pipe by feeding a length of conduit at a controlled rate through a bending mechanism while also continuously rotating the pipe at a controlled rate so that bending occurs in multiple axis directions and the diameter of the helical path of the conduit centerline of the coil is less than the conduit diameter, the pitch is greater than the pipe diameter, and a straight open channel is retained through the pipe coil.

### CROSS-REFERENCE TO RELATED APPLICATIONS

This patent application claims the benefit of U.S. Provisional Patent Application No. 60/874,848, filed Dec. 14, 2006, which is incorporated by reference in its entirety herein.

### FIELD OF THE INVENTION

This invention pertains to a method and apparatus for forming bent conduit or pipe of various sizes that can be used for a variety of applications, including but not limited to hydrodynamic mixing with no moving parts, generally known in the industry as a static mixer. This invention provides a method and apparatus which can be utilized to form the undulating conduit disclosed and claimed in my below mentioned applications and U.S. Pat. No. 6,896,007, which is highly effective for extraction of oil from oil sands deposits present in many countries throughout the world.

### BACKGROUND OF THE INVENTION

Various methods and apparatus are employed to bend or form lengths of pipe. In U.S. Pat. No. 4,317,353, an automated apparatus is shown for forming helical corrugations in tubing by a twisting operation. However, such apparatus and methodology creates ridges and valleys in the interior of the pipe, which when formed as shown in the reference, can produce undesirable flow properties for fluid passing through the pipe. Furthermore, such apparatus and methodology would not likely be practical for large-diameter conduits or for pipes made of certain materials. A hydraulic pipe bender is disclosed in Sheen U.S. Pat. No. 5,431,035 issued Jul. 11, 1995. As with all prior bending operations, the pipe is bent only in one axis direction and it is not undulating in the interior.

### BRIEF SUMMARY OF THE INVENTION

Accordingly, the present invention provides the methodology and equipment to form undulating conduit or pipe, which is bent in multiple axes directions in the nature of a helix, and where the conduit or pipe diameter is larger than the diameter of the helical path of the conduit centerline.

The invention comprises forming conduit of various diameters including, but not limited to, large size conduit or pipe, into an undulating helical pipe. The conduit used may be any suitable shape in its internal diameter (such as round), but preferably relatively continuous and smooth. The external cross section of the conduit may be any suitable shape. The coil is formed by feeding the conduit or pipe at a controlled rate through a bending mechanism while also rotating it at a controlled rate such that bending occurs in multiple axis directions through 360 degrees. The diameter of the resulting helical path of the conduit centerline is less than the pipe diameter, while the pitch is greater than the pipe diameter so that a straight open circular channel is retained through the pipe coil. The combination of the helical shape of the internal walls of the conduit and the straight open round channel through the pipe coil imparts hydrodynamic mixing particularly to slurries flowed through the pipe.

A method is disclosed of forming an undulating pipe comprising, providing a substantially straight pipe having a longitudinal axis through the center of the pipe, providing a bending apparatus including a system for feeding the pipe through the bending apparatus, moving the pipe in an axial direction through the bending apparatus, the bending apparatus asserting a force on the pipe to arcuately bend the pipe, and simultaneously rotating the pipe about the longitudinal axis as the pipe is moving in the axial direction such that the pipe undulates in a generally helical path.

The bending apparatus may include a plurality of rollers. The bending apparatus may comprise a feed roller and a bending roller. The interior of the pipe may include a continuous smooth interior wall throughout a length of the pipe. The pipe may have an interior wall that is circular in cross-section at every position along a length of the pipe. The pipe may be moved and rotated at rates such that the pitch is substantially greater than one pipe diameter. The pipe may be moved and rotated at rates such that the pitch is a multiple of the pipe diameter. The pipe may be moved and rotated at rates such that the radius of the helical path is smaller than the radius of the interior of the pipe.

An undulating pipe formed by the method is also disclosed. The undulating pipe may be a hydrodynamic static mixing apparatus for flowing fluidized slurries, the pipe having a preselected and predetermined configuration and length for mixing and/or transporting various substances including highly abrasive solids contained in slurries, said pipe being interconnected into a transportation and processing separation system for such slurries, said pipe having an internal radius rc and the undulations are formed by a coil having a radius rh such that the diameter of the conduit is greater than the coil diameter, means for pumping said fluidized slurry through an undulating interior of the pipe at some stage of transportation through the separation system, and said undulating interior configuration causing dynamic mixing of flowing slurries as said slurries are pumped through the pipe.

The undulating pipe may be a hydrodynamic static mixing apparatus having a preselected and predetermined configuration and length for mixing and/or transporting various substances, including fluids and solids contained in slurries, said pipe having an interior forming a helical coil having a pitch and with the diameter of the interior being greater than a coil helix diameter, said pipe including a generally round internal cross-section having a radius rc and a generally helical undulation having a path radius rh, said pipe, including an open inner channel along the longitudinal axis of the conduit, the inner channel having a radius ri that is substantially equal to rc−rh, the pitch of the helical coil being greater than one pipe diameter and said pipe is adapted to be incorporated into systems that perform one or more of the functions of fluid or slurry transport, processing and separation.

### BRIEF DESCRIPTION OF THE DRAWINGS

FIG. 1 shows a diagrammatic view of the working principle of the present invention for straight-feed without rotation;

FIG. 2 is a diagrammatic view showing the operation of the bender mechanism with controlled feeding and controlled rotation to form undulating pipe;

FIGS. 3a and 3b are two-dimensional illustrative side sectional views of a formed conduit;

FIG. 3c is an end view showing the undulating configuration with desired open channel interior produced by the bending operation;

FIG. 4a is an end view of a length of helically undulating conduit having a circular cross-section and an open center channel;

FIG. 4b is a shallow perspective side view of the helically undulating conduit of FIG. 4a;

FIG. 4c is a steep perspective side view of the helically undulating conduit of FIG. 4a;

FIG. 5 is an illustrative representation of the end views of several alternative cross-sectional shapes for undulating conduits;

FIG. 6a is an illustrative side view of an alternative form of undulating conduit mixer in which the pitch of the helical undulation is non-zero and the radius of the helical undulation is zero, for the case where the undulating conduit has an oval cross-section and the direction of rotating undulation is abruptly reversed to provide a short region of intense mixing in the conduit;

FIG. 6b is a magnified end view of the conduit in FIG. 6a, showing the open central channel provided by a spiral-twisted undulating conduit having an oval cross-section;

FIG. 6c is an illustrative trimetric view of a short section of the conduit of FIG. 6b inserted as a flow revitalizer between two sections of standard cylindrical pipe;

FIG. 7 is a flow diagram of an oil sands bitumen extraction method utilizing undulating conduits of the present invention;

FIG. 8 is a simplified diagram showing various pipe cross-sections showing a settling of solids to the bottom of the pipe such as would occur when the flow through the pipe has stopped; and

FIG. 9 is a simplified end view of a length of helically undulating conduit having a circular cross-section and an open center channel.

### DETAILED DESCRIPTION OF THE INVENTION

The invention provides a method and apparatus for forming an undulating pipe having a helical interior path. A pipe of this kind may be used for the transmission of fluids or slurries. The helical undulating shape may help to transmit slurries in such a manner that solids disposed within the fluid may travel in a suspended state to limit the amount of solid material that may collect near the bottom of the pipe.

For example, in the application of oil field drilling, it is common that the oil slurry removed from the earth would contain a mixture of liquid and solid particles, such as oil sands. This mixture is commonly transported from the drilling site to a remote location for separation of the slurry. In straight pipes, the solid material in the slurry tends to collect near the bottom of the pipe, thus obstructing transport. In pipes having undulation in a single plane, the solid material tends to collect in the valleys of the undulating pipe and the abrasiveness of the slurry wears down the pipe. The invention provides a method of forming a pipe having an interior that undulates in a helical path such that the solid material is substantially transported in a suspended state in the fluid.

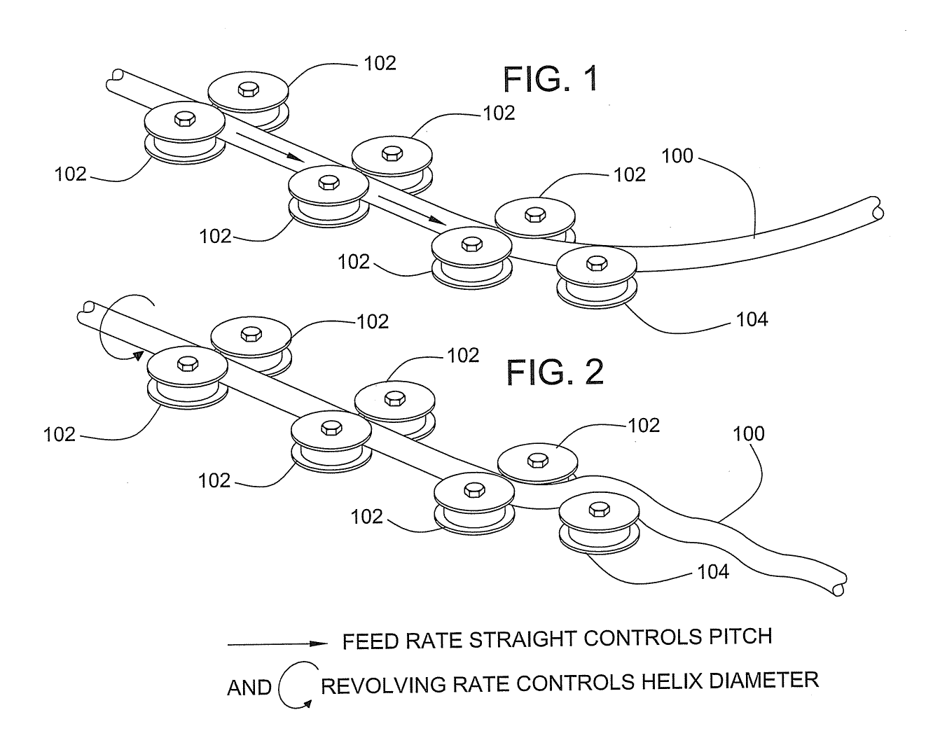

An example of a machine capable of bending conduit is shown for example in U.S. Pat. No. 5,431,035, incorporated herein by reference. The bending machine may comprise frame elements, rollers, gears, a clutch, mechanisms for lifting, guiding, feeding and bending, and operating systems including, for example, electronic controls and hydraulics. Referring to FIG. 1, a system of rollers 102 is shown with a pipe 100 progressing thereby in a single direction for accomplishing single-axis bending of the pipe 100. As shown, roller 104 imparts the bending force on the pipe 100, while rollers 102 serve as feed rollers for directing the pipe toward the roller 104. The roller 104 is offset with the rollers 102 to bend the pipe. The resulting pipe formed by such a process is curved into a coil having a relatively large radius of curvature. It will be appreciated that any suitable number of rollers may be utilized to form a pipe having an undulating helical interior pathway.

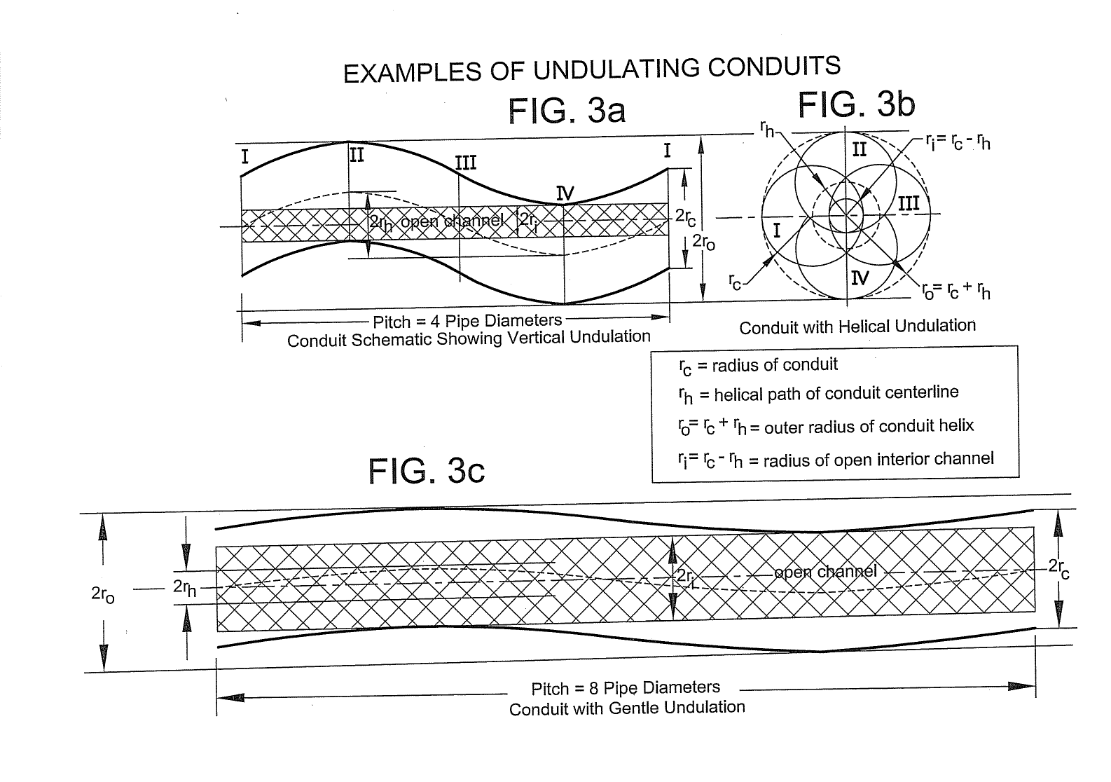

Turning to FIG. 2, a mechanism is provided to impart a rotation to the pipe 100 as it progresses through the system of rollers 102. The rotation mechanism may continuously and controllably rotate the pipe 100 along with a controlled feed rate. The revolving rate determines the diameter of the helix of the coil and the feed rate controls the pitch or length of a single undulation imparted to the pipe. Examples of undulating pipe having various pitches are shown, for example, in FIGS. 3a and 3c. The desired relationships for a pipe suitable in transportation, conditioning and separating oil sands, or for the transportation of oilsands tailings, for example, include having the diameter of the helical path of the conduit centerline which is less than the pipe diameter, a pitch that is a substantially greater than the pipe diameter (and in some embodiments, approximately a multiple of the diameter) and an open channel through the pipe. The properties of the undulating helical pipe as specified herein may be useful in the transportation of slurries containing abrasive solids in order to create a mixing effect to suspend the solid material in the slurry and also to reduce the amount of wear experienced in the interior of the pipe.

In some embodiments, the interior wall of the pipe has a continuous smooth surface, although it will be appreciated that the interior surface may have any suitable surface property. Furthermore, in some embodiments, the interior wall may be round in cross-section throughout the length of the pipe, although it will be appreciated that the pipe interior may have any suitable shape. A representative set of example cross-sectional shapes is shown in FIGS. 5a-5d. It will also be appreciated that the exterior of the pipe may be any suitable shape. For example, the exterior of the pipe may be generally circular as shown in FIG. 2. In other embodiments, the exterior of the pipe may be non-circular. In some non-circular embodiments, the feeding and/or bending mechanisms may need adjustment to accommodate the non-circular shape, and/or a framing mechanism may be utilized around the pipe.

The diameter and pitch of the undulating pipe may be tailored, within the defined parameters, to best suit the particular application for the pipe whether it is for maximizing the effectiveness of static mixing, conditioning of oilsands slurries for maximum oil recovery, or for maximum reduction of pumping horsepower and wear for tailings transport. Moreover, by varying the feed rate of smaller diameter conduit through the machine, along with the rate and direction in which it is rotated, a wide variety of pitch and helix diameters, with either left handed or right handed rotational direction, can be interspersed in the same length of conduit in order to achieve multiple hydraulic objectives. It will be appreciated that the pipe used in oil filed applications is typically large diameter pipe, such as described further below, however, it will be appreciated that an undulating helical pipe of any suitable diameter may be formed as described herein.

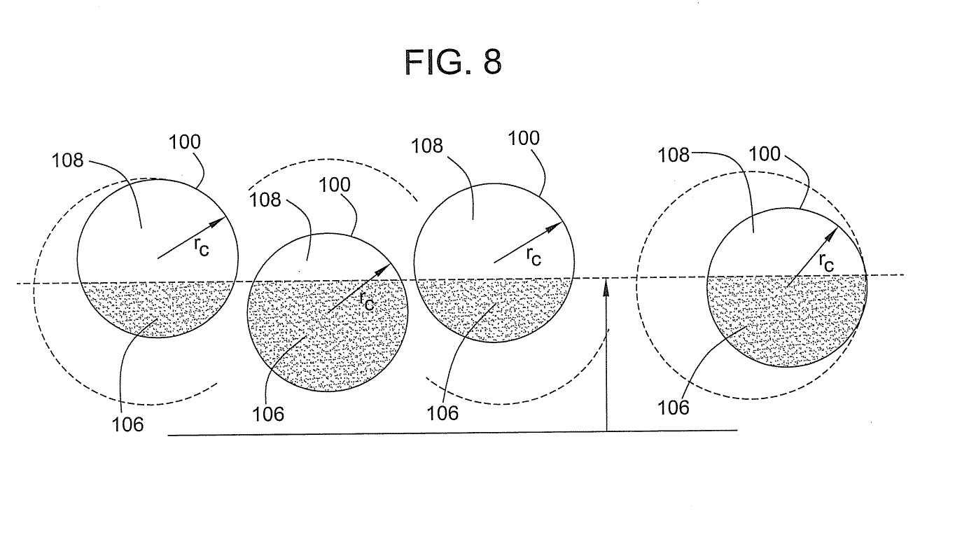

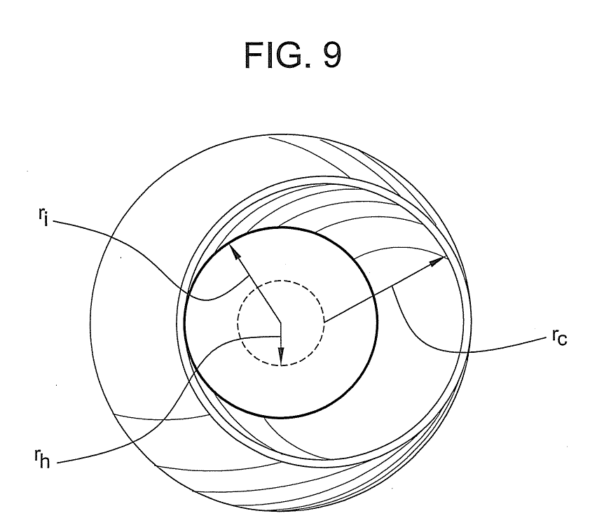

FIG. 8 shows a variety of cross-sectional positions along the pipe length. As shown, when the flow of slurry is stopped, the solid material 106 in the slurry may settle toward the bottom of the pipe and the liquid portion 108 of the slurry will generally occupy the remainder of the pipe interior. Specifically, this figure estimates the level of settled sand in a pipe (in horizontal position), when slurry flow of about 65 wt. % solids is suddenly interrupted. When flow restarts, resuspension of settled solids is aided by transverse secondary flows in the liquid moving through the open pipe cross-section above the settled solids.

FIG. 9 is a simplified end view of a undulating helical pipe showing the open pathway through the pipe, the radius of which is represented by rᵢ. The radius of the conduit is represented as r_{c}. The radius of the helical path of the conduit centerline is represented by rₕ.

The Undulating Conduit Hydrodynamic Mixer—The undulating conduit hydrodynamic mixer is the physical plant that provides controlled continuous positive dynamic interaction within the transported slurry. The undulating conduit creates the optimum environment for mixing of the oil sands slurry. The action may be described as directional flow changes, accelerating and decelerating, twirling, spiraling, gyrating, folding the slurry over on itself and stretching the mixture as it is transported.

The above pattern of dynamic flow provides several advantages usually not available in present mixing systems.

Referring to FIGS. 3a and 3b, the undulating conduit hydrodynamic mixer is a static mixing apparatus of a preselected and predetermined length of elongated tubular conduit. It allows for mixing and transporting various substances including highly abrasive solids-containing slurries. As further discussed herein, the conduit member can be interconnected into a transportation and processing separation system.

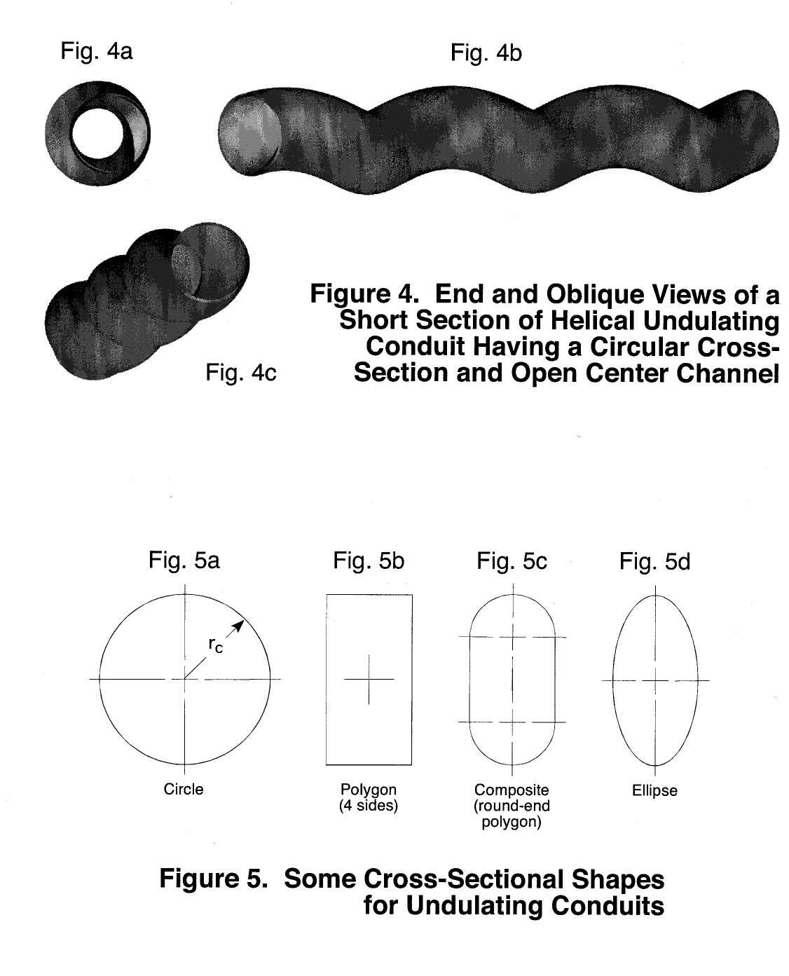

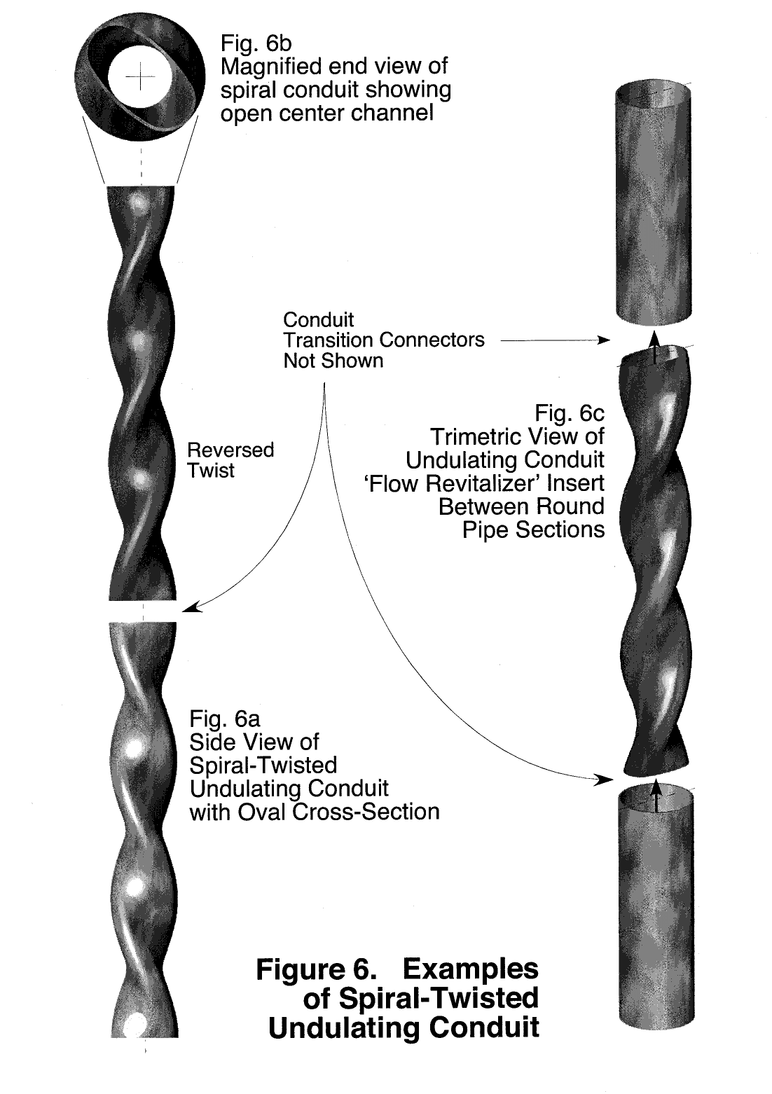

In accordance with the present invention, the undulations may take a variety of serpentine paths or shapes with various pitches (FIG. 3a-3c), repetitive or varying waves and differing cross sections, FIGS. 4, 4a, 5, 6. The undulations can be of a helical type formation (i.e., coil spring configuration) such as could be advantageously used for round pipe cross-sections, or a spiraled screw type shape for pipes of oval, polygonal, or other geometric cross-sections or combinations thereof, or the undulations can be sinusoidal when the conduit is not free to undulate in three dimensions.

It is not necessary that the conduit walls be of uniform thickness. For example, the exterior surface of the conduit could have a cylindrical pipe shape, while the interior surface of the conduit could have an undulating shape, thereby forming an undulating passage inside an externally cylindrical pipe of varying wall thickness. Such a design is particularly appropriate for small diameter undulating conduits or for relatively short ‘revitalizer’ sections of undulating conduit. It will be appreciated that the use of other than round conduit, or other than a mathematically precise helix for the path of undulation, is also permissible as well without deviating from the intent of this invention.

Helical type undulations are defined by geometry, having parameters such as conduit radius, radius and pitch of the helical path of the conduit centerline, the offset between the centerline of the conduit cross-section and the centerline of the helical path, and the inner and outer radii of the resulting conduit undulations.

Spiraled screw-shaped undulations are a special case of helical undulation in which the radius of the helical path undulation is zero but the pitch of undulation is non-zero. Spiraled screw undulations can be defined by parameters such as the spiral screw pitch, the offset between the conduit cross-section centerline and the centerline of the spiral path, and the cross-sectional shape of the conduit, for instance, oval, elliptical, semicircular, polygonal, or a combination thereof, or other non-circular shape.

Undulations can be formed by indenting the outside of a conduit in a spiraled screw type manner. The indentations can be grouped and placed at predetermined intervals. In an example for conduits containing slurried solids, the indentations may be limited to the upper portion of the conduit only and do not extend around the full circumference. Upper-surface indentations leave a straight conduit bottom that offers less resistance to sliding solids, is less prone to wear, and has no pockets to capture settled solids and impede resuspension during startup after a shutdown. During restart, the upper-surface undulations create currents angled down toward the conduit bottom, which disturb the settled solids and revitalize the flow.

Resuspension of Settled Solids.—In yet another embodiment of the Undulating Conduit Hydrodynamic Mixer, it is particularly advantageous for the conduit to follow a helical path whose radius rh is less than the conduit hydraulic radius r_{c}. This configuration provides an open inner channel of radius rᵢ=r_{c}−rₕ along the longitudinal axis of the undulating conduit, through which it is possible for fluid to flow in a straight line without undulation. With this configuration, even if the lower undulations of the conduit are almost completely plugged with settled solids after an unplanned shutdown, this center channel allows fluid to be pumped through the unplugged upper undulations of the conduit. The flow follows the conduit's upper undulations and develops primary and secondary motions that aid resuspension of settled solids in the conduit's lower undulations, thereby returning the entire conduit to the fluidized flow condition.

Premature Separation/Stratification.—The transportation of slurries of various compositions particularly in large diameter straight pipes (10″+) tends to give rise to premature separation and/or stratification of elements.

By choosing appropriate geometry parameters, the undulating conduit hydrodynamic mixer lends itself to precise control and therefore management of the flow, while the alternating primary and secondary flow patterns create a mixing effect which prevents premature separation and stratification of fluid components transported within the pipeline.

Flow Velocity. The swirling action in the undulating conduit hydrodynamic mixer keeps solids in constant suspension, which means that deposition of solids along the base of the pipe is considerably less than in a straight pipe; ergo, lower velocities of slurry travel are feasible without causing deposition. The lower velocity significantly reduces the abrasive effect of the solids.

Slurry Conditioning. The entry of screened slurry into the undulating conduit hydrodynamic mixer, brings with it lumps of oil sand reduced in size for additional digestion.

The swirling flow pattern in the undulating conduit hydrodynamic mixer is conducive to better abrading and digestion of lumps.

The “folding-over” mixing action of the undulating conduit hydrodynamic mixer enhances the contact and attachment of air to the oil droplets thus enhancing the conditioning of the slurry.

Economy of Development of the Invention Prototype. Since the undulating conduit hydrodynamic mixer system is based on principles of hydraulic flow, most of its parameters can be established theoretically and a numerical model developed and proven experimentally within a relatively short time and at a reasonable cost.

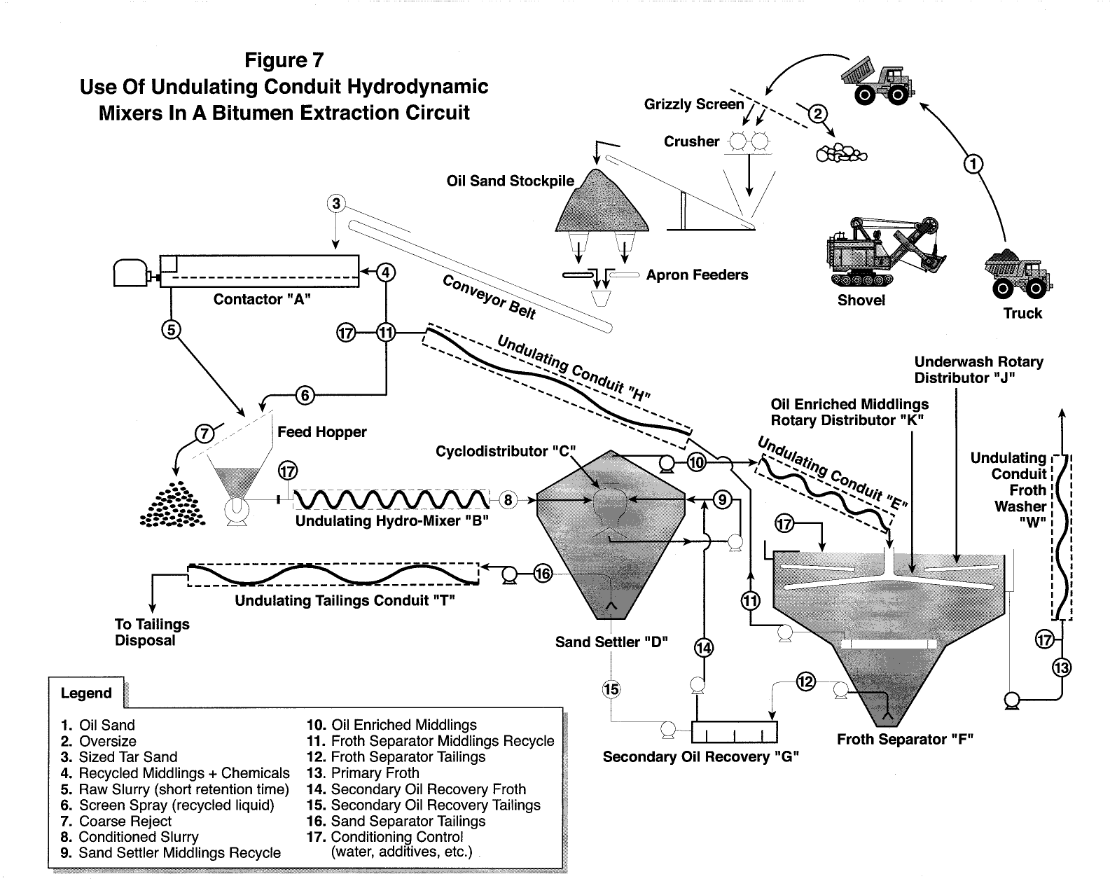

The Undulating Conduit Hydrodynamic Mixer Can Be Utilized in Several Phases of Mixing, Transport and Separation. The undulating conduit hydrodynamic mixer lends itself to use in at least three stages of mixing, transport and extraction, as illustrated in FIG. 7. A description of the oil sand extraction process shown in this Figure is provided in the following sections.

Stage #1—Undulating conduit hydrodynamic mixer (B) inserted as a hydro-dynamic mixer between contactor (A) and sand settler (D). The oil sand slurry is preconditioned in the contactor (A) as dense media. Contactor (A) is shown as a pug mill in FIG. 7. However, this function could also be provided by an undulating conduit hydrodynamic mixer.

After one or two minutes of mixing, the slurry is diluted and pumped through the undulating conduit hydrodynamic mixer (B) where it is further conditioned before entering the sand settler (D) and cyclo distributor (C). The diluted dense media slurry stream (8) will have a typical weight composition of approximately 65% solids, 10% bitumen and the remainder water. The components of the diluted dense media must stay in suspension between (A) and (D) to prevent conglomerates forming from the solids, bitumen and fines. The swirling flow of the undulating conduit hydrodynamic mixer keeps these components in suspension until the slurry reaches the flotation stage. This also prevents rapid conduit wear that would otherwise be caused by settled solids sliding between (A) and (D).

In Stage #2, the introduction of the undulating conduit hydrodynamic mixer (E) in transportation of the oil-laden middlings from the sand settler (D) to the froth separator (F) prevents premature coalescence of aerated oil globules and solids. The undulating conduit hydrodynamic mixer maintains the contents as a well-mixed suspension so that they can be evenly distributed across the Froth Separator area to yield optimum product.

In stage #3, the undulating conduit hydrodynamic mixer (H) will transfer middlings from the froth separator (F) to the contactor (A), to be used as a slurry dilution stream. The function of the undulating conduit hydrodynamic mixer between (F) and (A) is to maintain a homogeneous fluid suspension and thereby prevent formation of viscous amalgams that could restrict the flow. The working of this system enhances oil recovery by bringing the unaerated oil droplets back into the system, and also recycles fines that enhance transport of the slurry.

In stage #4, the undulating conduit hydrodynamic mixer (T) will transfer tailings from the sand separator (D) to the tailings disposal area. The tailings stream (16) will have a typical weight composition of approximately 65% coarse and fine solids, less than 2% bitumen and the remainder water. The function of the undulating hydrodynamic mixing conduit (T) is to maintain a well-fluidized tailings slurry that can be pumped at high density without causing rapid localized abrasive wear due to settled solids sliding along the conduit bottom. The undulating hydrodynamic mixing conduit will also be resistant to plugging with settled solids during a tailings line shutdown.

Mobility of the Undulating Conduit Hydrodynamic Mixer. The undulating conduit hydrodynamic mixer can be structured to be compact and mobile, so that it can be moved about in the mining sites if necessary.

Cost Effectiveness. The undulating conduit hydrodynamic mixer can displace some of the mixing equipment which is in current use at a considerably lower capital cost, lower operational and maintenance cost, and reduced down time to repair and/or replace worn out equipment.

The Process Described in the Application of this Invention. Oil sands contain sharp, various sized grains of sand particles, bitumen (a high viscosity oil) and connate water containing various amounts of corrosive chlorides. Conditioning starts in contactor (A) with the addition of fresh water, middlings from froth separator and chemicals if required.

The next step in preparation of slurry is accomplished in the hydrodynamic mixer, where it will be gently conditioned by thoroughly mixing while air, chemicals, predetermined energy and set time will be applied.

The next function is accomplished in the sand settler (D). Here, the slurry is diluted, mixed with recycled middlings in the cyclodistributor (C) followed by settling of the sand and floating of oil and middlings.

Settled sand, diluted by tailings from secondary oil recovery is removed for disposal while oil and floating middlings are transported by undulating conduit hydrodynamic mixer, to prevent coalescence of aerated oil droplets with high solids middlings, to the Froth Separator (“F”). In this stage of process, oil is floated off and removed as final froth while middlings containing liquid, some oil and fines (solid particles usually less than 44 microns), are recycled to the Contactor.

Static Undulating Conduit Hydrodynamic Mixer Management of Settling and Flotation Problems. The transport of slurry in straight pipes is subject to the problem of blockage caused by solids. At times of reduced velocities and/or stoppage, heterogeneous slurries, such as oil sand slurry, settle rapidly to form a sandy or hard deposit.

Similarly, in particular when processing high oil content ore (+12%), the spontaneous rise of aerated oil droplets forms a viscous amalgam at the top of the conduit, which increases in size with time of travel, building up system pressure and restricting the flow of slurry.

Solids suspended in the aerated viscous amalgam layer also cause high conduit wear where this layer slides along the conduit walls. The viscous amalgam layer is dispersed, or is prevented from forming, by the low-shear mixing action of slurry flow within the undulating conduit hydrodynamic mixer.

The undulating conduit hydrodynamic mixer will overcome the above deteriorating conditions, even at the low fluid velocities of laminar flow, by keeping the slurry in a state of gentle swirling flow. The slurry is subjected to continuous flow direction changes, vortexing and rotation, and as a result the elements are kept in motion.

Undulating Conduit Hydrodynamic Mixer Management of Abrasion Problem. By keeping solids in suspension the abrasive aspect of moving sand will be reduced. The velocity can be reduced without loss of mixing benefit; the sands are evenly distributed within the slurry, which also minimizes the abrasive effect on the walls of the conduit. With the sands in continuous suspension there is no settlement to the bottom of the conduit to create uneven wear on its base. In other words, the total wear factor is both reduced and spread out evenly within the pipe.

Applications. This invention offers a great range of potential applications. It is a mixer and can also serve as a materials transporter that incorporates a controlled mixing function.

Some uses are oil extraction from Alberta oil sands (water wet sand grains); U.S. oil sands (oil coated sand grains); and oil sands deposits in other parts of the world.

Various utilities such as water treatment plants and sewage treatment plants.

Industrial uses such as petrochemical industries, various solids transport industries such as transport of potash ore, coal and other mined minerals, dredging of harbors and rivers, paint manufacturing, and the food preparation industry. It can enhance and improve existing systems by the principle of the undulating conduit apparatus.

One particular use to which this invention is suited is in the extraction of oil from the Fort McMurray oil sands deposits in the vicinity of the Athabasca River in northeastern Alberta, Canada. Because of the smaller size of the apparatus, its low capital cost, lower operating expenses and portability, this invention has potential to allow the development of marginal oil sands deposits by small-scale operators.

This capability may be of benefit to less prosperous countries and smaller regional economies that have oil sands deposits.

Explanation of Flow Diagram (FIG. 7) Showing Utilization of Static Undulating Conduit Hydrodynamic Mixer in the Proposed Oil Extraction Process.

FIG. 7 is an example flow sheet for a method of separating oil from oil sands.

Contactor (A). The contactor is a sturdy mixing device for preconditioning of the oil sand slurry. The Contactor accomplishes oil sand lump digestion efficiently with a minimum of emulsification of the bitumen. A Pug Mill contactor can perform the required oil sand lump digestion and slurry preconditioning, or alternatively an Undulating Conduit Hydrodynamic Mixing contactor can be used for this purpose.

The contactor can be mounted and operated on mobile trailers, thus increasing mining flexibility. Retention time at this stage should preferably be short (a minute or two) while holding slurry consistency around 25% liquid by weight (including connate water).

The temperature of slurry at this stage, should be maintained around 30-55° C., to enhance diminution of tar sand lumps, thus liberating bitumen matrix intact.

To control the density of the above slurry, a stream (4) containing recycled middlings from the froth separator (F), chemicals and possibly fresh water is added.

After mixing is completed, this slurry (5) overflows the lip of the contactor and then falls through the screen into the pump hopper.

Fresh hot water (6) or a recycle stream (11) can be applied to dilute and propel this slurry through the screen openings, as well as to wash attached oil off the rejected oversize lumps (7).

The size of rejects (7) is dictated by the handling capability of the downstream equipment, in this case, the diameter of Undulating Conduit Hydrodynamic Mixer (B). During cold winter months, rejects containing frozen lumps of undigested oil sand might be recycled back to the Contactor (A).

Process Additives. The final adjustment of slurry density, the slurry pH, as well as addition of dissolved air, can be made via stream (17), before it enters the Undulating Conduit Hydrodynamic Mixer. Using the undulating conduit (in contrast to a straight pipe), the addition of dissolved air could be tolerated without increasing the flow stratification and possible pipe wear by aerated viscous amalgam.

The screened preconditioned slurry with additives (17) is pumped through the Undulating Conduit Hydrodynamic Mixer. For effective mixing, one to two minutes of retention time should be adequate.

Static Hydrodynamic Mixer Undulating Conduit. The static hydrodynamic mixer undulating conduit can be used in various configurations to fulfill different functions. In FIG. 7, five static hydrodynamic mixer undulating conduits are utilized (shown as B, E, H, T and W). The hydrodynamic mixer can be utilized firstly as a pure mixer to blend fluid components together. Secondly, it can be utilized as a transporter mixer to simultaneously mix and transport the conduit contents. Thirdly, it can serve as inserts in a transportation pipe system to revitalize the contents in transit.

The static hydrodynamic mixer undulating conduit can be used as a mixer only, by applying a small length of conduit having undulations of a short pitch configuration. This static hydrodynamic mixer undulating conduit unit could be mounted on mobile equipment and operated close to the mining area.

The static hydrodynamic mixer undulating conduit could also consist of a combined mixing and transport system having continuous long-pitch undulations or a combination of straight pipes with insertions of undulating pipes. The correct design of this unit, establishing length and diameter of conduit, and diameter and pitch of the undulation, could positively influence the product quality and reduce related expenses.

Sand Settler (D). Sand accounts for around 80% of the oil sand weight. As much sand as possible should be removed from the slurry as early as possible to avoid abrasive wear on downstream equipment. The sand settler should therefore be installed as near as possible to the mine to reduce the need to transport large volumes of solids out of the mine area.

Conditioned slurry (8) is introduced into the sand settler (D) by means of the cyclodistributor (C). Here it is dispersed and diluted by recycled middlings stream (9), which also induces additional rotational momentum. The resulting motion enhances turbulence within the middlings in the lower section of the vessel, thus preventing the formation of gels (pseudo-plastic behavior).

The cyclonic action within the cyclodistributor enhances the separation of sand and aerated oil droplets by means of turbulence and density differential.

After exiting the cyclodistributor, rising aerated oil droplets and some middlings are floated to the top of the vessel and then leave the sand separator by means of a stream (10) which passes through an Undulating Conduit Hydrodynamic Mixer (E) functioning as a transporter/mixer that prevents conglomeration and stratification of aerated oil droplets.

The sand-laden portion of the slurry is discharged onto the conical deflector where it fans and spreads out. This allows any oil carried by the outflowing stream to escape. The released oil rises to the top, while the descending sand is uniformly distributed across the lower portion of the sand settler.

As the sand slides down the walls and settles towards the bottom of the settler, it densifies and releases middlings fluid and bitumen. The build-up of densified sand on the bottom creates a sand-middlings interface that acts as a seal to exclude oil-bearing middlings from the tailings stream (16).

The flux of released middlings and bitumen creates an upward flow current towards the cone under the cyclone distributor, where the released middlings and bitumen join stream (9).

The density of tailings stream (16) drawn from the bottom of the vessel, is controlled by injection of secondary oil recovery tailings (15).

Froth Separator (F). Oil-enriched middlings stream (10) is transported from the sand settler to the froth separator by means of the Undulating Conduit Hydrodynamic Mixer, which prevents coagulation of aerated oil droplets. The stream enters the froth separator via the rotary distributor (K) and is laid down uniformly across the vessel.

Streams exiting the rotating distributor (K) are mixed with surrounding liquid and, thus diluted, are the first step of the actual process of separation.

The released aerated oil globules rise to the top of the vessel, where they form a bituminous froth (13), while coarse and fine sand particles, and some unaerated bitumen, settle to the bottom of the froth separator.

Underwash. Fresh (pretreated) underwash water is introduced preferably by way of underwash rotary distributor (J) beneath the froth layer, but above the oil enriched middlings distributor (K). In this way, a highly diluted zone is provided, through which the ascending bitumen passes immediately before joining the froth. This step contributes to formation of higher froth quality by washing rising aerated bitumen droplets and maintaining a mild downward current that depresses the fines to the middlings withdrawal pipe (11). There is usually more underwash water than middlings water in the froth product, suggesting that only excess underwash water is involved in the downward flow. The dilute underwash zone leads not only to clean froth, but also maintains stable operation even when high fines oil sands are being processed.

Primary Froth. Rising to the surface, aerated oil globules form a froth (13), on average containing 60-70% oil, 6-10% solids and 20-30% water, which overflows into launders and is pumped to froth treatment facilities. An Undulating Conduit Hydrodynamic Mixer (W) may be a suitable apparatus for washing the froth. Froth washing gently shears and stretches conglomerated droplets of aerated bitumen that have trapped solids and water in the interstices between the clumped droplets. The gentle low-shear scrubbing action of fluid motion inside the undulating conduit (W) liberates the trapped solids and water in the froth without creating an emulsion and moving solids towards and close to walls of the conduit by centrifugal force, to be removed, shortly before discharging a product.

Middlings Recycle. The middlings for recycle to the contactor (11) are taken from the froth separator via a collector pipe. By this means a certain percentage of solids (mostly as fines) are removed from the center of the froth separator (F). The withdrawal of stream (11) creates gentle shear within the center zone of the froth separator, which helps prevent the remaining fines from coalescing or gelling. Stream (11) should be transferred to the contactor (A) via Undulating Conduit Hydrodynamic Mixer to prevent formation of viscous amalgams that could restrict the flow.

Secondary Oil Recovery. Froth separator tailings (12) are withdrawn and introduced into the secondary oil recovery system (G).

Secondary Oil Recovery Froth. The product of secondary oil recovery system (14), a froth high in solids, which is introduced into middlings recycle stream (9) and forwarded to the cyclodistributor.

Secondary Oil Recovery Tailings. A low oil content discharge stream (15) from the secondary oil recovery circuit enters the sand settler (D) as a sand tailings dilution and fluidizing stream.

Sand Separator (D) Tailings. A high-solids, low oil content discharge stream (16) leaves the Sand Settler (D) and is pumped to the Sand Tailings disposal area via an Undulating Hydrodynamic Mixing Conduit (T). The function of this undulating mixer conduit is to maintain a well-fluidized tailings slurry that can be efficiently pumped at high density without excessive wear of the conduit due to sliding stratified solids. The undulating conduit is also resistant to plugging with settled solids during a tailings line shutdown.

It will be appreciated that the terms conduit and pipe are used interchangeably herein.

Although the invention has been described with respect to bending pipes for application in oil field slurry transport, it will be appreciated that the undulating helical pipe may be utilized for any suitable application.

For further discussion of undulating helical pipe, please see Applicant's U.S. patent application Ser. No. 11/525,668, filed on Sep. 22, 2006; U.S. patent application Ser. No. 10/736,485, filed on Dec. 15, 2003, now abandoned; and U.S. provisional patent application Ser. No. 60/392,281, filed on Jun. 28, 2002, as well as U.S. Pat. No. 6,896,007, all of which are incorporated herein by reference.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor for carrying out the invention. Variations of these preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of forming an undulating pipe comprising:
providing a substantially straight pipe having a longitudinal axis through the center of the pipe;
providing a bending apparatus including a system for feeding the pipe through the bending apparatus;
moving the pipe in an axial direction through the bending apparatus, the bending apparatus asserting a force on the pipe to arcuately bend the pipe; and
simultaneously rotating the pipe about the longitudinal axis as the pipe is moving in the axial direction such that the pipe undulates in a generally helical path.

2. The method of claim 1 wherein the bending apparatus includes a plurality of rollers.

3. The method of claim 2 wherein the bending apparatus comprises a feed roller and a bending roller.

4. The method of claim 1 wherein the interior of the pipe includes a continuous smooth interior wall throughout a length of the pipe.

5. The method of claim 1 wherein the pipe has an interior wall that is circular in cross-section at every position along a length of the pipe.

6. The method of claim 1 wherein the pipe is moved and rotated at rates such that the pitch is substantially greater than one pipe diameter.

7. The method of claim 6 wherein the pipe is moved and rotated at rates such that the pitch is a multiple of the pipe diameter.

8. The method of claim 1 wherein the pipe is moved and rotated at rates such that the radius of the helical path is smaller than the radius of the interior of the pipe.

9. An undulating pipe formed by the method of claim 1.

10. The undulating pipe of claim 9 wherein the pipe is a hydro-dynamic static mixing apparatus for flowing fluidized slurries, the pipe having a preselected and predetermined configuration and length for mixing and/or transporting various substances including highly abrasive solids contained in slurries, said pipe being interconnected into a transportation and processing separation system for such slurries, said pipe having an internal radius r_{c} and the undulations are formed by a coil having a radius rₕ such that the diameter of the conduit is greater than the coil diameter, means for pumping said fluidized slurry through an undulating interior of the pipe at some stage of transportation through the separation system, and said undulating interior configuration causing dynamic mixing of flowing slurries as said slurries are pumped through the pipe.

11. The undulating pipe of claim 9 wherein the pipe is a hydrodynamic static mixing apparatus having a preselected and predetermined configuration and length for mixing and/or transporting various substances, including fluids and solids contained in slurries, said pipe having an interior forming a helical coil having a pitch and with the diameter of the interior being greater than a coil helix diameter, said pipe including a generally round internal cross-section having a radius r_{c} and a generally helical undulation having a path radius rₕ, said pipe, including an open inner channel along the longitudinal axis of the conduit, the inner channel having a radius rᵢ that is substantially equal to r_{c}−rₕ, the pitch of the helical coil being greater than one pipe diameter and said pipe is adapted to be incorporated into systems that perform one or more of the functions of fluid or slurry transport, processing and separation.
